(19) United States
(12) Patent Application Publication
(10) Pub. No.: US 2013/0288652 A1
(43) Pub. Date: Oct. 31, 2013

(54) Lawful Interception of Speech Communication in a Communication Network

(71) Applicant: Angelo Ciriaco, Vico Equense (IT)

(72) Inventor: Angelo Ciriaco, Vico Equense (IT)

(73) Assignee: TELEFONAKTIEBOLAGET L M ERICSSON (PUBL), Stockholm (SE)

(21) Appl. No.: 13/977,770

(22) PCT Filed: Mar. 11, 2011
(86) PCT No.: PCT/EP11/53700

§ 371 Date: Jul. 18, 2013

(30) Foreign Application Priority Data
Jan. 5, 2011 (GB) 1100085.8

(51) Int. Cl. H04W 4/16

(52) U.S. Cl. CPC H04W 4/16
USPC 455/414.1

(57) ABSTRACT

A method and apparatus for use in a communication network. A node receives voice data relating to a voice sample of a subject and an identity of the subject. The voice data is associated with the identity of the subject and stored. A speech sample is subsequently received from a traffic node, the speech sample having been obtained from a telecommunications session. A comparison is made between the stored voice data and the speech sample, and a determination is made to check whether the speech sample is likely to belong to the subject. If so, then a message identifying the subject is sent towards an LEMF node. The LEMF node can then initiate lawful interception of the telecommunications session. The node allows a target subject to be identified by a voice sample, which makes it much more difficult for a target subject to avoid lawful interception by, for example, using a different device to make a call.

### TECHNICAL FIELD

The invention relates to the field of Lawful Interception in a communication network.

### BACKGROUND

Lawful Interception (LI) allows Law Enforcement Agencies (LEAs) to obtain communication network data for the purpose of analysis or gathering evidence. The data typically includes details of signalling, such as called and calling parties, and in some instances the contents of the call itself.

3GPP TS 33.107 “Lawful interception architecture and functions” describes the architecture and functional requirements with a Third Generation Mobile Communication System. FIG. 1 shows the architecture. A Law Enforcement Monitoring Facility (LEMF) 1 may be located in a 3G network or any other network. An Administration Function (ADMF) 2 communicates with the LEMF 1. Note that more than one LEMF is shown because the ADMF may communicate with several different LEMFs. Owing to different legal LI requirements, the LI information shared with different LEMFs may be different. For simplicity, the following discussing refers to a single LEMF 1. The ADMF 2 communicates with the LEMF 1 using a Mediation Function (MF) 3 via a HI1 interface.

Two Delivery Functions (DFs) are provided. DF2 4 communicates with the LEMF 1 via a HI2 interface and is used to send Intercept Related Information (IRI) to the LEMF 1 using a MF 5. DF2 4 receives IRI from the network via an X2 interface. In a Circuit Switched (CS) network, IRI is triggered by events that may be call-related or non-call related. In a Packet Switched (PS) network, IRI may be triggered by events that are session related or session unrelated.

DF3 6 receives the content of a communication subject to LI and sends this to the LEMF 1 using a MF 7 via a HI3 interface. DF3 6 is also responsible for call control in CS networks. The ADMF 2, DF2 4 and DF3 6 all communicate with a traffic node, also termed Intercepting Control Elements (ICE) 8. The form of the ICE depends on the network in which it is located. For example, an ICE in an IMS network could be a Proxy-Call Session Control Function (P-CSCF) or a Serving-Call Session Control Function (S-CSCF). It may be a Mobile Switching Centre (MSC) server in a 3G network, a Serving GPRS Support Node (SGSN), a Gateway GSN (GGSN), or a Media Gateway (MGW). An ICE performs interception, and in the event that there is more than one ICE, each ICE performs interception independently of other ICEs. Interception actions that the ICE performs include interrogation, activation, deactivation and invocation. Note that an ICE is sometimes referred to as an Intercept Access Point (IAP).

LI is typically based on target identities in order to identity called or calling parties that are subject to LI. A target identity allows the ICE to identify whether or not a party in a call is subject to LI and, if so, activate LI for the call. The target identities for 3GPP MS CS and GPRS interception at the SGSN, GGSN, 3G MSC Server and 3G GMSC Server are typically an International Mobile Subscriber Identity (IMSI), a Mobile Station International ISDN Number (MSISDN) or an International Mobile Equipment Identity (IMEI). The IMSI and the MSISDN typically identify the subscription, whereas the IMEI identifies the equipment itself.

Most users who may be the subject of LI are aware that they can be identified using the IMSI, MSISDN or IMEI, and that calls that they make that use any of these identifiers is likely to be intercepted. It is easy for such a person to frequently change their mobile equipment and/or subscription, for example by replacing their Subscriber Identity Module (SIM). This changes their target identities and makes LI very difficult on the basis of the target identities mentioned above.

### SUMMARY

It has been realised that performing LI on the basis of target identities means that it is relatively easy for a person subject to LI to avoid their calls being intercepted. It is an object of the present invention to increase the chance of identifying a person subject to LI even where the person changes mobile equipment and/or subscription.

According to a first aspect, there is provided a node for use in a communication network. The node is provided with a first receiver for receiving from a remote node voice data relating to a voice sample of a subject and an identity of the subject. A computer readable medium in the form of a memory is used to store the voice data associated with the identity of the subject. A second receiver is provided for receiving a speech sample from a traffic node. The speech sample has been obtained from a telecommunications session. A processor is used for comparing the stored voice data and the speech sample, and it determines whether the speech sample is likely to belong to the subject. A transmitter is also provided. If it is determined that the speech sample is likely to belong to the subject, the transmitter sends a message identifying the subject to a Law Enforcement Monitoring Facility (LEMF). The node allows a target subject to be identified by a voice sample, which has the advantage of making it much more difficult for a target subject to avoid lawful interception by, for example, using a different device to make a call.

In an optional embodiment, the voice data comprises a voice sample, although it will be appreciated that it could alternatively be metadata relating to the voice sample that can be used to identify the speech sample.

The speech sample is optionally received from an ongoing telecommunication session. It will be appreciated that the invention can also be implemented when a recorded speech sample is used.

According to a second aspect, there is provided a LEMF node for use in a communication network. The LEMF node is provided with a receiver for receiving a message from a remote node. The message indicates that a speech sample from a telecommunication session corresponds with a voice sample associated with a subject who is subject to lawful interception. The message also includes intercept related information (IRI). A processor is used for generating an instructing message for instructing lawful interception. The instructing message comprises at least part of the IRI. A transmitter is provided for sending the instructing message towards a traffic node. In this way, when the LEMF is informed that a positive match has been found between a voice sample and a speech sample, it can then use the received IRI to initiate lawful interception.

As an option, the LEMF is provided with a memory for storing data relating to the voice sample associated with the subject who is subject to lawful interception. A further transmitter is provided for, prior to receiving from the message from the remote node, sending towards the remote node a message that contains the data relating to the voice sample.

The processor is optionally arranged to use the received IRI to locate a device used by the subject.

According to a third aspect, there is provided a traffic node for use in a telecommunication network. The traffic node is provided with a receiver for receiving an instructing message. The instructing message includes at least one criterion, and an instruction to generate speech samples from telecommunications sessions meeting the criterion. A second receiver is provided for receiving data from m a telecommunications session. A processor obtains a speech sample from the received data and a transmitter is provided for sending to a further node a message, the message including the speech sample and further IRI.

The IRI optionally includes any of an International Mobile Equipment Identity, an International Mobile Subscriber Identity, a Mobile Station International ISDN Number and a Cell ID. These can all be used to instruct lawful interception

According to a fourth aspect, there is provided a method of operating a node in a communication network. The method includes receiving, from a remote node, voice data relating to a voice sample of a subject and an identity of the subject. The voice data is associated with the identity of the subject and stored. A speech sample is subsequently received from a traffic node, the speech sample having been obtained from a telecommunications session. A comparison is made between the stored voice data and the speech sample, and a determination is made to check whether the speech sample is likely to belong to the subject. If so, then a message identifying the subject is sent towards an LEMF node.

The voice data optionally comprises a voice sample, or could alternatively comprise metadata relating to the voice sample.

As an option, the speech sample is received from an ongoing telecommunication session.

According to a fifth aspect, there is provided a method of operating a LEMF node in a communication session. The LEMF receives a message from a remote node. The message indicates that a speech sample from a telecommunication session corresponds with a voice sample associated with a subject who is subject to lawful interception. The message also includes IRI. An instructing message for instructing lawful interception is generated. The instructing message includes at least part of the IRI. The instructing message is then sent towards a traffic node. This allows the LEMF to instruct lawful interception on the basis of a positive match between a voice sample and a speech sample.

As an option the method comprises, prior to receiving from the message from the remote node, sending a message that contains the data relating to the voice sample towards the remote node.

According to a sixth aspect, there is provided a method of operating a traffic node in a telecommunication network. The method includes receiving an instructing message, the instructing message comprising at least one criterion and an instruction to generate speech samples from telecommunications sessions meeting the criterion. Data is received from a telecommunications session, and a speech sample is obtained from the received data. A message is sent to a further node, the message including the speech sample and further IRI.

The IRI optionally comprises any of an International Mobile Equipment Identity, an International Mobile Subscriber Identity, a Mobile Station International ISDN Number and a Cell ID.

According to a seventh aspect, there is provided a computer program comprising computer readable code means which, when run on a node, causes the node to perform the method as described above in the fourth aspect.

According to a eighth aspect, there is provided a computer program comprising computer readable code means which, when run on a LEMF node, causes the LEMF node to perform the method as described above in the fifth aspect.

According to an ninth aspect, there is provided a computer program comprising computer readable code means which, when run on a traffic node, causes the traffic node to perform the method as described above in the sixth aspect.

According to a tenth aspect, there is provided a computer program product comprising a computer readable medium and a computer program as described above in any of the seventh, eighth or ninth aspects, wherein the computer program is stored on the computer readable medium.

### BRIEF DESCRIPTION OF THE DRAWINGS

FIG. 1 illustrates schematically in a block diagram a known network architecture for performing Lawful Interception;

FIG. 2 illustrates schematically in a block diagram a network architecture according to an embodiment of the invention;

FIG. 3 illustrates schematically in a block diagram a network node according to an embodiment of the invention;

FIG. 4 is a signalling diagram showing signalling required according to an embodiment of the invention;

FIG. 5 illustrates schematically in a block diagram a LEMF node according to an embodiment of the invention; and

FIG. 6 illustrates schematically in a block diagram a traffic node according to an embodiment of the invention.

### DETAILED DESCRIPTION

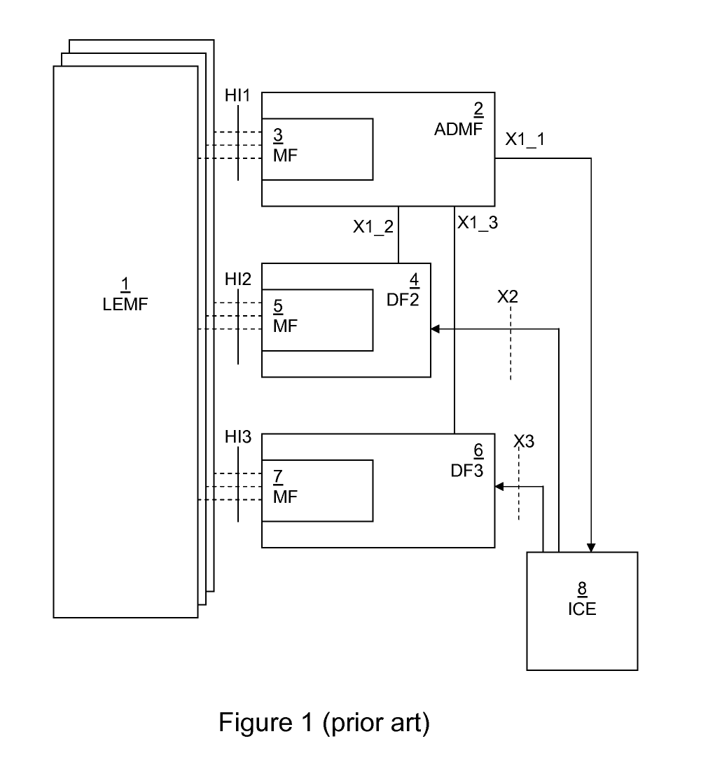

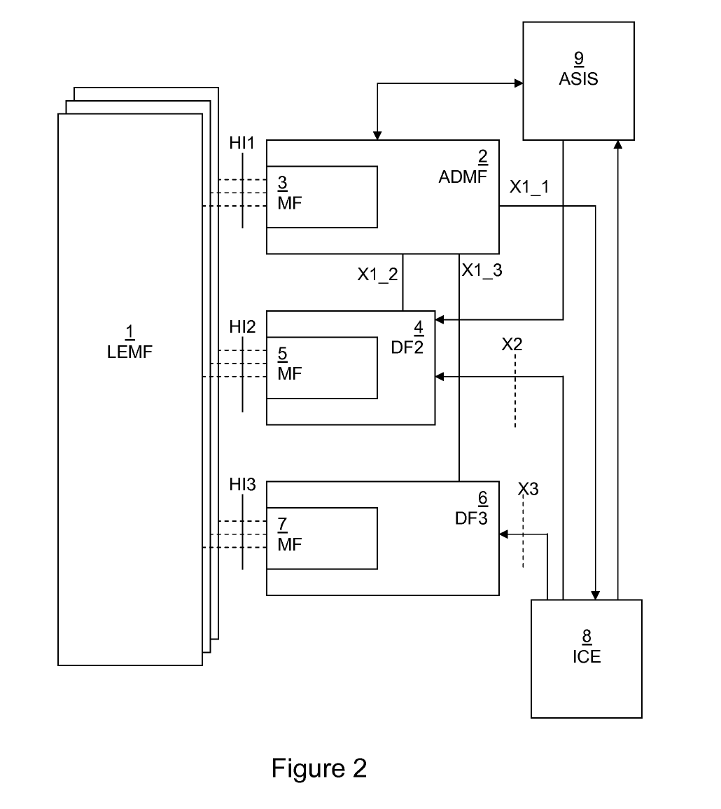

Referring to FIG. 2 herein, there is illustrated a network architecture according to an embodiment of the invention. The figure shows the same basic network architecture as that shown in FIG. 1, with the addition of a speaker identification node (termed herein an Automatic Speaker Identification System, ASIS). In this embodiment, the ASIS can communicate with the ADMF 2 and the ICE 8.

The ASIS makes a comparison between stored voice samples of people known to be subject to LI and speech samples from sessions and determines whether a speech sample from a session call arises from a person known to be subject to LI. In this way the voice sample takes the place of a target identity. However, the user will not be able to evade LI by simply changing their SIM or Mobile Equipment, and so the ICE will much more effectively identify a person that is subject to LI. The term “voice sample” is used herein to refer to a stored voice sample relating to a person, and the term “speech sample” is used to refer to a sample of a voice taken from a call. The term “session” is used herein to refer to any type of telecommunications session in which a user's voice is transmitted, such as a voice call or a video call.

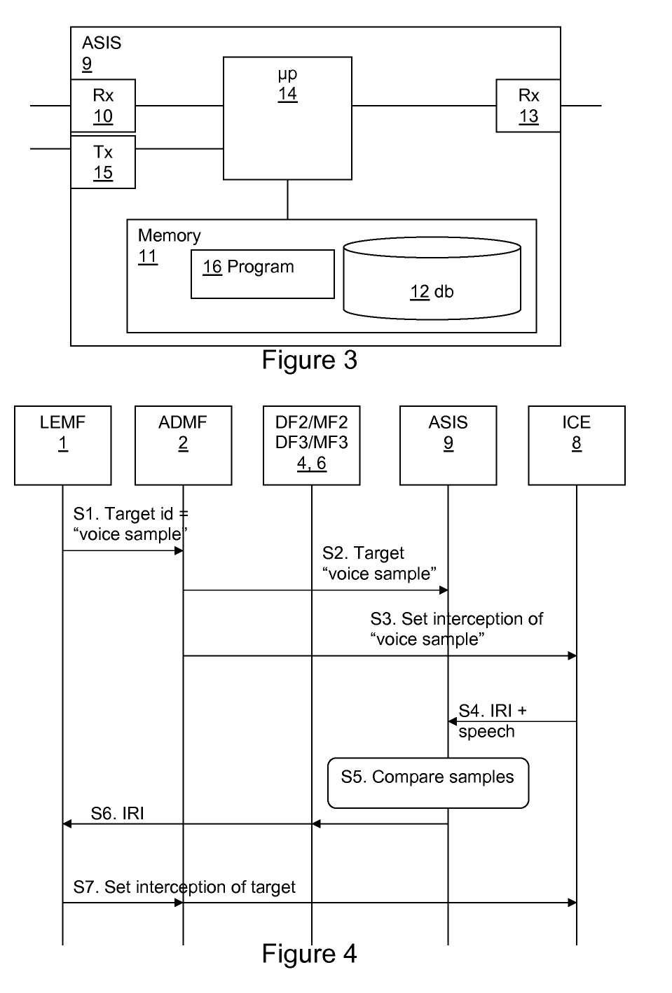

FIG. 3 shows an example of an ASIS (9). While this is illustrated as hardware and as a separate node, it will be appreciated that many of the functions may be implemented by software and that the ASIS (9) may be part of whichever physical computer device implements the ICE (8) functions.

The ASIS 9 has a receiver 10 that is used to receive data relating to a voice sample from a LEMF 1. The data relating to the voice sample is associated with a person who is subject to lawful interception. The data relating to the voice sample includes an identity of the subject and typically includes a voice sample itself, which may be sent in any suitable format such as MP3, WAV, etc, but it may alternatively include metadata relating to the voice sample that can be used to perform a match with a speech sample.

The data relating to the voice sample is stored on a computer readable medium in the form of a memory 11, typically in a database 12 that stores the data relating to the voice sample and maps this data to an identity of the person.

A second receiver 13 is provided for receiving a speech sample from a telecommunications session, provided by a traffic node 8. The traffic node 8 provides speech samples to the ASIS 9 for all call sessions that it handles, within certain criteria. Examples of criteria that may be applied to the speech sample sent by the traffic node 8 include all call sessions that originate from a certain Cell ID, all terminating call sessions to a cluster of Cell IDs etc. The speech sample will typically be obtained from an ongoing call session, although there are circumstances where it may be obtained from a recorded call session.

The ASIS 9 further comprises a processor 14 for performing a comparison between the received speech sample and the voice data stored in the database, and determining whether there is a match between any of the voice data and the speech sample. If so, then the speech sample is likely to belong to a person that is subject to lawful interception. The comparison is not dependent on language used and/or channel (landline phones, mobile phones, VoIP).

A transmitter 15 is provided for, in the event that it is determined that the speech sample is likely to belong to the subject, sending a message towards the LEMF 1 informing the LEMF 1 that a match for a subject has been found. The message includes the identity of the subject. This allows the LEFM to instruct the traffic node 8 to initiate lawful interception for the call session.

The memory 11 may also be used to store a computer program 16 which, when executed by the processor 14, causes the ASIS to behave as described above.

Turning now to FIG. 4, there a signalling diagram shows the signalling over the network. The following numbering corresponds to the numbering of FIG. 4:

S1. The LEMF 1 has a database of voice samples relating to people who are subject to lawful interception. It sends data relating to voice sample to an ADMF 2.

S2. The ADMF 2 forwards the data relating to the voice sample to the ASIS 9, which the ASIS 9 can then store along with an identifier associated with the voice sample.

S3. The ADMF 2 also sends a message to the traffic node 8, informing the traffic node that speech samples are required for call sessions handled by the traffic node 8. This may also include further criteria, such as call sessions originating from certain Cell IDs etc., as discussed above.

S4. The traffic node handles a call session, and sends a speech sample from the call session to the ASIS 9, along with IRI relating to the call session.

S5. The ASIS 9 compares the speech sample received from the traffic node 8 with a voice sample stored at its database.

S6. If the received speech sample matches a voice sample, then the ASIS 9 sends the IRI relating to the call session to the LEMF 1, via the DF2 4. The message informs the LEMF 1 that a match has been found between a voice sample and a speech sample, and an identity associated with the voice sample.

S7. The LEMF 7 generates an instructing message for instructing lawful interception, and sends the instructing message towards the traffic node 8. The instructing message includes at least part of the IRI (such as the MSISDN, IMSI, IMEI, Cell ID etc) to allow the traffic node 8 to identify the call session. The traffic node can then begin lawful interception for the session.

The LEMF node 1 can also use the received IRI to locate the device being used by the subject using existing location/intercept features available to the LEMF node 1.

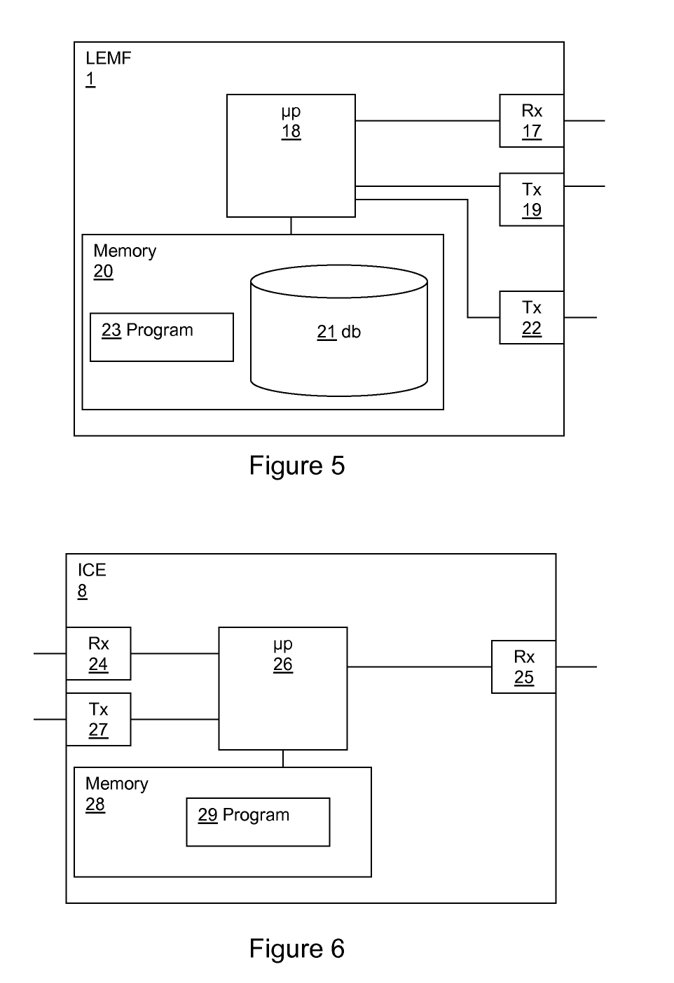

Referring to FIG. 5 herein, there is illustrated a LEMF node 1. The LEMF node 1 is provided with a receiver 17 for receiving a message from the ASIS 9 that includes an indication that a speech sample from a call session corresponds with a voice sample of a subject. The message also includes the IRI relating to the call session. A processor 18 generates an instructing message for instructing lawful interception. The instructing message includes at least part of the IRI to allow the traffic node 8 to identify the call session. A transmitter 19 is provided for sending the instructing message towards the traffic node 8.

The LEMF node 1 may also be provided with a computer readable medium in the form of a memory 20 for storing data relating to the voice sample (typically a voice sample itself), and an identity of the subject associated with the voice sample. A further transmitter 22 is provided for sending the data relating to the voice sample towards the ASIS 9.

The memory 20 may also be used to store a computer program 23 which, when executed by the processor 18, causes the LEMF node 1 to behave as described above.

Referring to FIG. 6 herein, there is illustrated a traffic node 8. The traffic node 8 is provided with a receiver 24 for receiving an instructing message from the ADMF 2. The instructing message includes at least one criterion (such as a cell ID for originating call sessions, as discussed above) and an instruction to generate speech samples from call sessions meeting the criterion. A second receiver 25 is provided for receiving data from a call session. A processor 26 obtains a speech sample from the received data, and a transmitter 27 sends the speech sample and further Intercept Related Information in a message to the ASIS 6. The IRI typically includes any of an IMEI, an IMSI, a Cell ID and a MSISDN.

A computer readable medium in the form of a memory 28 may also be provided. This can be used to store a computer program 29 which, when executed by the processor 26, causes the traffic node 8 to behave as described above.

The invention enhances lawful interception to allow an LEA to instruct LI on the basis of a voice sample, in addition to the known methods of detecting call sessions. The voice sample (or data obtained from a voice sample) can effectively be used as an additional target ID. The LEA can ask the LI system to intercept call sessions carrying speech from suspects/criminals/terrorists whose voice prints are known. The results of the interception are typically IRI records with call session information such as an IMSI, MSISDN, IMEI, Cell ID and so on. This allows real time further interception and/or localization of the equipment used by the person.

It will be appreciated by the person of skill in the art that various modifications may be made to the above described embodiments without departing from the scope of the present invention as defined in the appended claims.

The following abbreviations have been used in this specification:
ADMF Administration Function
ASIS Automatic Speaker Identification System
CS Circuit Switched
DF Delivery Functions
GGSN Gateway GSN
IAP Intercept Access Point
ICE Intercepting Control Elements
IMEI International Mobile Equipment Identity
IMSI International Mobile Subscriber Identity
IRI Intercept Related Information
LEMF Law Enforcement Monitoring Facility
MF Mediation Function
MGW Media Gateway
MSC Mobile Switching Centre
MSISDN Mobile Station International ISDN Number
P-CSCF Proxy-Call Session Control Function
PS Packet Switched
S-CSCF Serving -Call Session Control Function
SGSN Serving GPRS Support Node
SIM Subscriber Identity Module

1-19. (canceled)

20. A node for use in a communication network, the node comprising:
a first receiver configured to receive, from a remote node, voice data relating to a voice sample of a subject and an identity of the subject;
memory configured to store the voice data associated with the identity of the subject;
a second receiver configured to receive, from a traffic node, a speech sample from a telecommunications session along with intercept related information relating to the session;
a processor configured to determine whether the speech sample is likely to belong to the subject by comparing the stored voice data and the speech sample;
a transmitter configured to, in the event that the processor determines that the speech sample is likely to belong to the subject, send a message towards a Law Enforcement Monitoring Facility node, the message identifying the subject and the intercept related information relating to the session.

21. The node of claim 20, wherein the voice data comprises a voice sample.

22. The node of claim 20, wherein the speech sample is from an ongoing telecommunication session.

23. A Law Enforcement Monitoring Facility node for use in a communication network, the Law Enforcement Monitoring Facility node comprising:
a receiver configured to receive a message from a node, the message:
indicating that a speech sample from a telecommunication session corresponds with a voice sample associated with a subject who is subject to lawful interception; and
comprising intercept related information;
a processor configured to generate an instructing message for instructing lawful interception, the instructing message comprising at least part of the intercept related information; and
a transmitter configured to send the instructing message towards a traffic node.

24. The Law Enforcement Monitoring Facility node of claim 23, further comprising:
memory configured to store data relating to the voice sample associated with the subject who is subject to lawful interception;
a further transmitter configured to, prior to receiving from the message from the remote node, send a further message towards the remote node, the further message comprising data relating to the voice sample.

25. The Law Enforcement Monitoring Facility node of claim 23, wherein the processor is further configured to use the received intercept related information to locate a device used by the subject.

26. A traffic node for use in a telecommunication network, the traffic node comprising:
a receiver configured to receive an instructing message, the instructing message comprising:
at least one criterion; and
an instruction to generate speech samples from telecommunications sessions satisfying the criterion;
a second receiver configured to receive data from a telecommunications session;
a processor configured to obtain a speech sample from the received data if the telecommunication session satisfies the criterion;
a transmitter configured to send a message to a further node, the message including the speech sample and intercept related information.

27. The traffic node of claim 26, wherein the intercept related information comprises at least one of:
an International Mobile Equipment Identity;
an International Mobile Subscriber Identity;
a Mobile Station International ISDN Number;
a Cell ID.

28. A method of operating a node in a communication network, the method comprising receiving, from a remote node, voice data relating to a voice sample of a subject and an identity of the subject;
storing the voice data associated with the identity of the subject;
receiving, from a traffic node:
a speech sample from a telecommunications session;
intercept related information relating to the session;
determining whether the speech sample is likely to belong to the subject by comparing the stored voice data and the speech sample;
in response to the determining concluding that the speech sample is likely to belong to the subject, sending a message towards a Law Enforcement Monitoring Facility node, the message identifying the subject and the intercept related information relating to the session.

29. The method of claim 28, wherein the voice data comprises a voice sample.

30. The method of claim 28, wherein the speech sample is from an ongoing telecommunication session.

31. A method of operating a Law Enforcement Monitoring Facility node in a telecommunication network, the method comprising:
receiving a message from a remote node, the message:
indicating that a speech sample from a telecommunication session corresponds with a voice sample associated with a subject who is subject to lawful interception;
comprising intercept related information;
generating an instructing message for instructing lawful interception, the message comprising at least part of the intercept related information; and
sending the instructing message towards a traffic node.

32. The method of claim 31, further comprising, prior to receiving from the message from the remote node, sending a further message towards the remote node, the further message comprising data relating to the voice sample.

33. A method of operating a traffic node in a telecommunication network, the method comprising:
receiving an instructing message, the instructing message comprising:
at least one criterion; and
an instruction to generate speech samples from telecommunications sessions satisfying the criterion;
receiving data from a telecommunications session;
in response to the telecommunication session satisfying the criterion, obtaining a speech sample from the received data;
sending a message to a further node, the message including the speech sample and intercept related information.

34. The method of claim 33, wherein the intercept related information comprises at least one of:
an International Mobile Equipment Identity;
an International Mobile Subscriber Identity;
a Mobile Station International ISDN Number;
a Cell ID.

35. A computer program product stored in a non-transitory computer readable medium for operating a node in a communication network, the computer program product comprising software instructions which, when run on the node, causes the node to:
receive, from a remote node, voice data relating to a voice sample of a subject and an identity of the subject;
store the voice data associated with the identity of the subject;
receive from a traffic node:
a speech sample from a telecommunications session;
intercept related information relating to the session;
determine whether the speech sample is likely to belong to the subject by comparing the stored voice data and the speech sample;
in response to determining that the speech sample is likely to belong to the subject, send a message towards a Law Enforcement Monitoring Facility node, the message identifying the subject and the intercept related information relating to the session.

36. A computer program product stored in a non-transitory computer readable medium for operating a Law Enforcement Monitoring Facility (LEMF) node in a telecommunication network, the computer program product comprising software instructions which, when run on the LEMF node, causes the LEMF node to:
receive a message from a remote node, the message:
indicating that a speech sample from a telecommunication session corresponds with a voice sample associated with a subject who is subject to lawful interception;
comprising intercept related information;
generate an instructing message for instructing lawful interception, the message comprising at least part of the intercept related information; and
send the instructing message towards a traffic node.

37. A computer program product stored in a non-transitory computer readable medium for operating a traffic node in a telecommunication network, the computer program product comprising software instructions which, when run on the traffic node, causes the traffic node to:
receive an instructing message, the instructing message comprising:
at least one criterion; and
an instruction to generate speech samples from telecommunications sessions satisfying the criterion;
receive data from a telecommunications session;
in response to the telecommunication session satisfying the criterion, obtain a speech sample from the received data;
send a message to a further node, the message including the speech sample and intercept related information.
